(19) United States
(12) Patent Application Publication
(10) Pub. No.: US 2025/0320904 A1
(43) Pub. Date: Oct. 16, 2025

(54) FRICTION DAMPER

(71) Applicant: OBAYASHI CORPORATION, Tokyo (JP)

(72) Inventors: Yoshikazu UTSUMI, Tokyo (JP); Katsuhiro TOMII, Tokyo (JP)

(21) Appl. No.: 19/001,026

(22) Filed: Dec. 24, 2024

(30) Foreign Application Priority Data
Dec. 26, 2023 (JP) JP2023-219776
Dec. 11, 2024 (JP) JP2024-216870

(51) Int. Cl. F16F 7/08; F16C 29/00; F16C 29/02

(52) U.S. Cl. CPC F16F 7/08; F16C 29/002; F16C 29/025; F16F 2230/26; F16F 2238/04

(57) ABSTRACT

An aerodynamic bearing for mounting a shaft for a turbo compressor having two annular axial bearing disks and a hollow cylindrical radial bearing bush. The two axial bearing disks are spaced apart and form a cavity between them for receiving a shaft sleeve connected to the shaft, and the two axial bearing disks each have an axial bearing surface facing the cavity for forming an axial gas cushion in an axial bearing gap between the axial bearing surface and the shaft sleeve. The radial bearing bush has a radial bearing surface radially inward for forming a radial gas cushion in a radial bearing gap between the radial bearing surface and the shaft for the radial mounting of the shaft, and the radial bearing bush is formed integrally and/or materially with one of the axial bearing disks as a combination bearing bush.

### RELATED APPLICATIONS

The present application claims priority pursuant to 35 U.S.C. § 119 from Japanese patent application numbers 2023-219776 and 2024-216870 filed on Dec. 26, 2023, and Dec. 11, 2024, respectively, of which full contents are incorporated herein by reference.

### FIELD

The present disclosure relates to a friction damper.

### BACKGROUND

In the related art, as disclosed in PTL 1 (Japanese Patent Application Publication No. 2005-195179), for example, a friction damper is known in which, with a frictional force (frictional resistance force) generated between pressure-contact plates that move relative to each other in predetermined directions and slide against each other along with such a relative movement thereof, the vibrational energy caused by earthquakes or wind is dissipated to suppress the relative movement. In such a friction damper, a bolt extends through the pressure-contact plates that move relative to each other, a disc spring is disposed close to a head portion of the bolt, and a nut is screwed onto the bolt, so that the pressure-contact plates are brought into pressure contact with each other by a spring load-bearing force of the disc spring. In this case, in order to ensure that the spring load-bearing force of the disc spring is applied over a wider region of the pressure-contact plates, a flat washer is interposed on the nut side.

### BRIEF SUMMARY

In a friction damper such as that described in PTL 1 (Japanese Patent Application Publication No. 2005-195179), a force that is applied from the nut side and brings the pressure-contact plates into pressure contact with each other is likely to be applied over a narrow region in the vicinity of the nut, and thus, high frictional heat is likely to be generated due to a concentrated load. In addition, even in a case where the flat washer is interposed on the nut side, a spring load-bearing force is transmitted to the inner periphery side of the flat washer that is pressed by the nut, whereas the spring load-bearing force is less likely to transmitted to the outer periphery side of the flat washer that is pressed by the nut warps in a direction away from the pressure-contact plates. Thus, a region to which the spring load-bearing force is transmitted is substantially a narrow region where the nut is in contact with one of the pressure-contact plates, and there has been a problem in that the surface pressure increases due to the load being applied to the narrow region, resulting in generation of high frictional heat and making it difficult to obtain a desired frictional force.

An object of the present disclosure is to provide a friction damper in which a reduction in frictional force caused by frictional heat is less likely to occur.

To achieve the above-mentioned object, a friction damper according to the present disclosure includes: a pressure-contact-plate stack in which a plurality of pressure-contact plates are stacked on each other and slide against each other to generate a frictional force between the plurality of pressure-contact plates; a bolt that extends through the pressure-contact-plate stack; a nut that is screwed onto the bolt at a position on a side opposite to a head portion of the bolt; a first disc spring set that is disposed between the pressure-contact-plate stack and one of the head portion and the nut; and a second disc spring set that is disposed between the pressure-contact-plate stack and another one of the head portion and the nut. The frictional force is adjusted by a spring load-bearing force of the first disc spring set. A contact area of the second disc spring set with the pressure-contact-plate stack being larger than a contact area of the first disc spring set with the pressure-contact-plate stack.

Other features of the present disclosure will become apparent from the description provided in the present specification.

According to the present disclosure, it is possible to provide a friction damper in which a reduction in frictional force caused by frictional heat is less likely to occur.

### BRIEF DESCRIPTION OF THE DRAWINGS

FIG. 1 is a schematic elevation view of a beam-column frame provided with a friction damper of the present embodiment.

FIG. 2 is a sectional view taken along a line A-A in FIG. 1.

FIG. 3 is a sectional view taken along a line B-B in FIG. 2.

FIGS. 4A to 4C are schematic diagrams illustrating deformation of a second disc spring set.

FIG. 5A is a diagram illustrating a contact area of a first disc spring set, and

FIG. 5B is a diagram illustrating a contact area of the second disc spring set.

FIG. 6 is a diagram illustrating a friction damper according to a first modification.

FIG. 7 is a diagram illustrating a friction damper according to a second modification.

FIG. 8 is a sectional view of a friction damper including three pressure-contact plates.

FIG. 9 is a sectional view of a friction damper including five pressure-contact plates.

### DETAILED DESCRIPTION

At least the following matters will be clear with the description of this specification and the attached drawings.

### Aspect 1

A friction damper including: a pressure-contact-plate stack in which a plurality of pressure-contact plates are stacked on each other and slide against each other to generate a frictional force between the plurality of pressure-contact plates; a bolt that extends through the pressure-contact-plate stack; a nut that is screwed onto the bolt at a position on a side opposite to a head portion of the bolt; a first disc spring set that is disposed between the pressure-contact-plate stack and one of the head portion and the nut; and a second disc spring set that is disposed between the pressure-contact-plate stack and another one of the head portion and the nut, the frictional force being adjusted by a spring load-bearing force of the first disc spring set, a contact area of the second disc spring set with the pressure-contact-plate stack being larger than a contact area of the first disc spring set with the pressure-contact-plate stack.

Unlike a flat washer, the outer peripheral portion of a disc spring is not deformed by lifting and warping even when the disc spring is pressed and deformed to become substantially flat. Therefore, the first disc spring set and the second disc spring set are arranged as in the friction damper of Aspect 1, which can press the pressure-contact-plate stack at a position away from the axis of the bolt.

In addition, the contact area of the second disc spring set with the pressure-contact-plate stack is larger than the contact area of the first disc spring set with the pressure-contact-plate stack, and thus, the spring load-bearing force can be distributed and applied over a larger area. This suppresses the local concentration of the spring load-bearing force. As a result, a friction damper that suppresses generation of frictional heat and is less likely to occur a reduction in frictional force due to the frictional heat can be provided.

### Aspect 2

The friction damper according to Aspect 1 further including: a first washer that is disposed between the pressure-contact-plate stack and the one of the head portion and the nut, wherein, the first disc spring set is disposed between the pressure-contact-plate stack and the first washer.

According to the friction damper of Aspect 2, the first disc spring set can be pressed by the first washer, and the inner and outer diameters of a disc spring can be increased. Therefore, the spring load-bearing force of the first disc spring set can be applied over a wider region of the pressure-contact-plate stack.

### Aspect 3

The friction damper according to Aspect 2, the first washer includes: a flange that comes into contact with the one of the head portion and the nut; and a guide ring that is disposed inside the first disc spring set.

According to the friction damper of Aspect 3, the position of the first disc spring set can be more easily fixed by the guide ring of the first washer. In addition, the first disc spring set can be pressed against the pressure-contact-plate stack by the flange of the first washer.

### Aspect 4

The friction damper according to Aspect 1 further including: a second washer that is disposed between the pressure-contact-plate stack and the other one of the head portion and the nut, wherein the second disc spring set is disposed between the pressure-contact-plate stack and the second washer.

According to the friction damper of Aspect 4, the second disc spring set can be pressed by the second washer, and the inner and outer diameters of a disc spring can be increased. Therefore, the spring load-bearing force of the second disc spring set can be applied over a wider region of the pressure-contact-plate stack.

### Aspect 5

The friction damper according to Aspect 4, wherein the second washer includes: a flange that comes into contact with the other one of the head portion and the nut; and a guide ring that is disposed inside the second disc spring set.

According to the friction damper of Aspect 5, the position of the second disc spring set can be more easily fixed by the guide ring of the second washer.

In addition, the second disc spring set can be pressed against the pressure-contact-plate stack by the flange of the second washer.

### Aspect 6

The friction damper according to Aspect 1, wherein a contact region of the first disc spring set with the pressure-contact-plate stack corresponds to an outer peripheral edge portion of the first disc spring set.

According to the friction damper of Aspect 6, the contact region of the first disc spring set with the pressure-contact-plate stack corresponds to the outer peripheral edge portion of the first disc spring set, that is, the first disc spring set is in contact with the pressure-contact-plate stack at the outer peripheral edge portion of a disc spring. Thus, the first disc spring set is not deformed such that the entire surface thereof comes into contact with the pressure-contact-plate stack. Therefore, the spring load-bearing force of the first disc spring set can be applied at the outer peripheral edge portion of the first disc spring set, that is, at a position away from the axis of the bolt, and thus, the spring load-bearing force can be applied over a wider region.

### Aspect 7

The friction damper according to Aspect 1, wherein a contact region of the second disc spring set with the pressure-contact-plate stack extends from an outer peripheral edge portion of the second disc spring set to an inner peripheral edge portion of the second disc spring set.

According to the friction damper of Aspect 7, the contact region of the second disc spring set with the pressure-contact-plate stack extends from the outer peripheral edge portion of the second disc spring set to the inner peripheral edge portion of the second disc spring set, and thus, the contact area of the second disc spring set with the pressure-contact-plate stack can be reliably increased compared with a case where only the outer peripheral edge portion is in contact with the pressure-contact-plate stack. Therefore, the spring load-bearing force can be distributed and applied.

### Aspect 8

The friction damper according to Aspect 1, wherein the first disc spring set is a stack of a predetermined number of disc springs, and the second disc spring set has one disc spring or disc springs, the number of the disc springs being fewer than the predetermined number.

According to the friction damper of Aspect 8, the number of disc springs in the second disc spring set is fewer than the number of disc springs in the first disc spring set, and thus, tightening the nut allows the second disc spring set to begin to deform significantly before the first disc spring set deforms. Consequently, the second disc spring set deforms such that the contact region thereof with the pressure-contact-plate stack expands more than that of the first disc spring set, and thus, the contact region between the second disc spring set and the pressure-contact-plate stack can be wider than the contact region between the first disc spring set and the pressure-contact-plate stack.

### Aspect 9

The friction damper according to Aspect 8, wherein the second disc spring set is a stack of a plurality of the disc springs.

According to the friction damper of Aspect 9, the second disc spring set is a stack of the plurality of disc springs, and thus, the transmission efficiency of the spring load-bearing force can be improved compared with a single disc spring.

### Embodiment

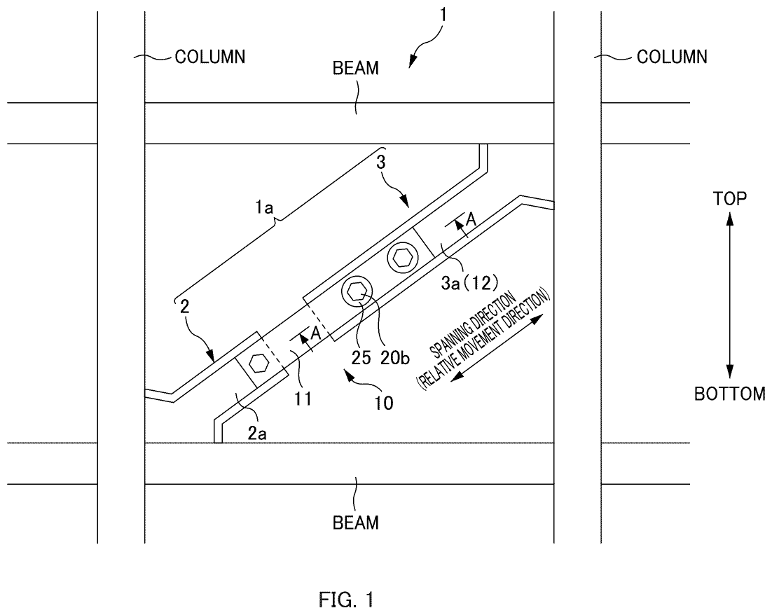

A friction damper according to an embodiment of the present disclosure will be described below with reference to the drawings. Note that, in the following description, identical or equivalent components, members, and the like illustrated in the drawings are denoted by the same reference signs, and repeated descriptions may be suitably omitted. As illustrated in FIG. 1, for example, a friction damper 10 is incorporated into an H-shaped steel brace 1a of a beam-column frame 1. The brace 1a includes brace-divided pieces 2 and 3 that are separated from each other by a predetermined distance at an appropriate position in a spanning direction of the brace 1a, and the friction damper 10 is incorporated in a portion at which the brace-divided pieces 2 and 3 are separated from each other. The friction damper 10 suppresses relative movement of the brace-divided pieces 2 and 3 in the spanning direction at a time of occurrence of an external force such as that caused by an earthquake.

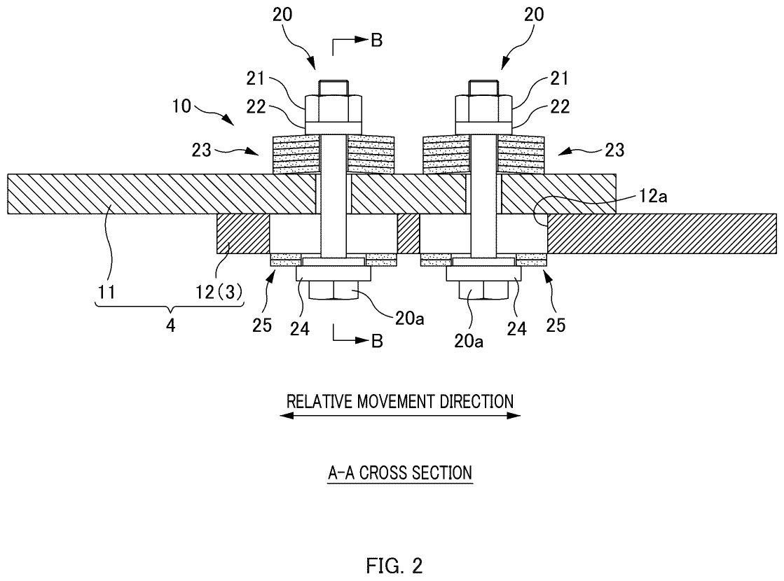

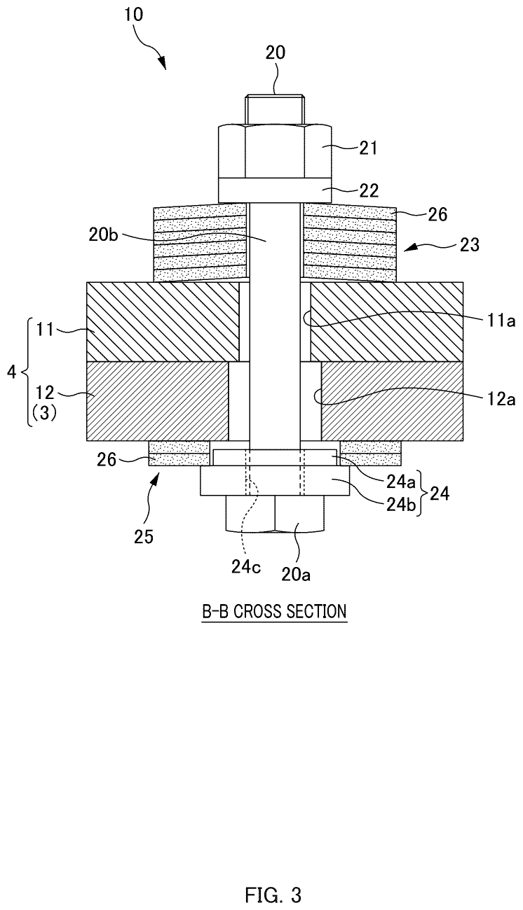

As illustrated in FIG. 2 and FIG. 3, the friction damper 10 includes a first pressure-contact plate 11, a second pressure-contact plate 12, high-strength bolts 20, nuts 21, first washers 22, first disc spring sets 23, second washers 24, and second disc spring sets 25. The first pressure-contact plate 11 is bolted to a web 2a of the brace-divided piece 2. A web 3a of the brace-divided piece 3 serves as the second pressure-contact plate 12 as it is. The high-strength bolts 20 pass through both the first pressure-contact plate 11 and the second pressure-contact plate 12. The nuts 21 are screwed onto their respective high-strength bolts 20. The first washers 22 and the first disc spring sets 23 are arranged close to the nuts 21. The second washers 24 and the second disc spring sets 25 are arranged close to head portions 20a of the high-strength bolts 20.

The first pressure-contact plate 11 has a first through hole 11a that is formed in such a manner as to extend through the first pressure-contact plate 11 in a plate-thickness direction thereof. The second pressure-contact plate 12 has a second through hole 12a that is formed in such a manner as to extend through the second pressure-contact plate 12 in a plate-thickness direction thereof. The first through hole 11a has a shape of a circle having a diameter slightly larger than the diameter of a shaft portion 20b of a corresponding one of the high-strength bolts 20. The second through hole 12a is a hole that is elongated in the spanning direction and has a width larger than the inner diameter of the first through hole 11a. The high-strength bolts 20 are inserted through the through holes 11a and 12a in such a manner as to pass completely through the first pressure-contact plate 11 and the second pressure-contact plate 12 that are stacked in the plate thickness direction, and the nuts 21 are screwed onto leading ends of the high-strength bolts 20, respectively.

The first washers 22 and the first disc spring sets 23 are arranged between the first pressure-contact plate 11 and the nuts 21 such that each of the high-strength bolts 20 is inserted through a corresponding one of the first washers 22 and a corresponding one of the first disc spring sets 23. The first washers 22 are positioned close to the nuts 21, and the first disc spring sets 23 are each positioned between the first pressure-contact plate 11 and a corresponding one of the first washers 22. Each of the first disc spring sets 23 is constituted by six disc springs 26 stacked on each other in parallel and is disposed such that an inner peripheral edge portion 26a side is positioned close to the corresponding first washer 22 side while an outer peripheral edge portion 26b side is positioned close to the first pressure-contact plate 11 side. The outer peripheral edge portion 26b is in contact with the first pressure-contact plate 11.

The second washers 24 and the second disc spring sets 25 are arranged between the second pressure-contact plate 12 and the head portions 20a of the high-strength bolts 20 (hereinafter simply referred to as “head portions”) such that the high-strength bolts 20 are inserted through the second washers 24 and the second disc spring sets 25, respectively. The second washers 24 are positioned close to the head portions 20a, and the second disc spring sets 25 are positioned between the second pressure-contact plate 12 and the second washers 24. Each of the second disc spring sets 25 is constituted by two disc springs 26 stacked on each other in parallel and is disposed such that the inner peripheral edge portion 26a side is oriented toward the corresponding second washer 24 while the outer peripheral edge portion 26b side is oriented toward the second pressure-contact plate 12.

Each of the second washers 24 has a small annular portion 24a and a large annular portion 24b that are integrally connected to each other in the thickness direction. The outer diameter of the small annular portion 24a and the outer diameter of the large annular portion 24b are different from each other. Each of the second washers 24 has a through hole 24c that is formed at the central portion thereof and that has an inner diameter slightly larger than the diameter of the shaft portion 20b of a corresponding one of the high-strength bolts 20.

The outer diameter of the small annular portion 24a of each of the second washers 24 is slightly smaller than the inner diameter of each of the disc springs 26, and the outer diameter of the large annular portion 24b of each of the second washers 24 is larger than the inner diameter of each of the disc springs 26. Each of the second washers 24 is disposed such that the small annular portion 24a is located inside the inner peripheral edge portion 26a of the corresponding second disc spring set 25 and such that the large annular portion 24b is located between the corresponding head portion 20a and the corresponding second disc spring set 25 (i.e., the large annular portion 24b comes in contact with the head portion 20a). Note that the small annular portion 24a of each of the second washers 24 corresponds to a guide ring, and the large annular portion 24b of each of the second washers 24 corresponds to a flange.

In the friction damper 10, tightening the nuts 21 generates a spring load-bearing force of the first disc spring sets 23, which applies a press-contact force between the first pressure-contact plate 11 and the second pressure-contact plate 12. In a state where the press-contact force is applied between the first pressure-contact plate 11 and the second pressure-contact plate 12, the first pressure-contact plate 11 and the second pressure-contact plate 12 are movable relative to each other while sliding against each other, and when they slide against each other, a frictional force is generated in proportion to the press-contact force. Such a frictional force serves as a damping force to reduce vibrations in the beam-column frame 1. Here, the first pressure-contact plate 11 and second pressure-contact plate 12 that are stacked on each other correspond to a pressure-contact-plate stack 4. In the pressure-contact-plate stack 4, a plurality of pressure-contact plates are stacked on each other and slide against each other to generate a frictional force therebetween.

When disc springs are stacked in the same direction, the load capacity increases compared to the characteristics of a single disc spring. Thus, in the friction damper 10, by changing the number of the disc springs 26 included in each of the first disc spring sets 23 and by adjusting the amount of change with respect to the free height of each of the first disc spring sets 23 when the nuts 21 are tightened, the spring load-bearing force of the first disc spring sets 23 can be varied to adjust the frictional force.

Tightening the nuts 21 that are respectively screwed onto the high-strength bolts 20 varies the spring load-bearing force of the first disc spring sets 23 and the second disc spring sets 25. Both the first disc spring sets 23 and the second disc spring sets 25 employ the same disc springs 26 and differ in the stacked number of disc springs 26. Accordingly, each of the second disc spring sets 25 in which the stacked number of disc springs 26 is smaller than that of each of the first disc spring sets 23 change in height more significantly than the first disc spring sets 23 in response to the tightening of the nuts 21.

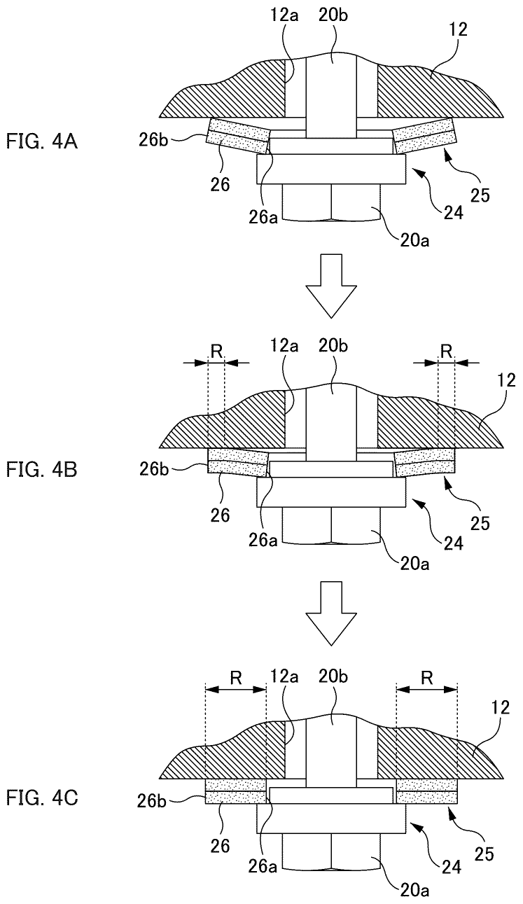

In this case, as illustrated in FIG. 4A and FIG. 4B, the disc springs 26 of the second disc spring sets 25 bend and deform in the stacked state so as to approach the second pressure-contact plate 12 from the outer peripheral edge portions 26b side. As the nuts 21 are further tightened in order to increase the spring load-bearing force of the first disc spring sets 23, contact regions R where the disc springs 26 of the second disc spring sets 25 come in contact with the second pressure-contact plate 12 expand from the outer peripheral edge portion 26b side toward the inner peripheral edge portion 26a side.

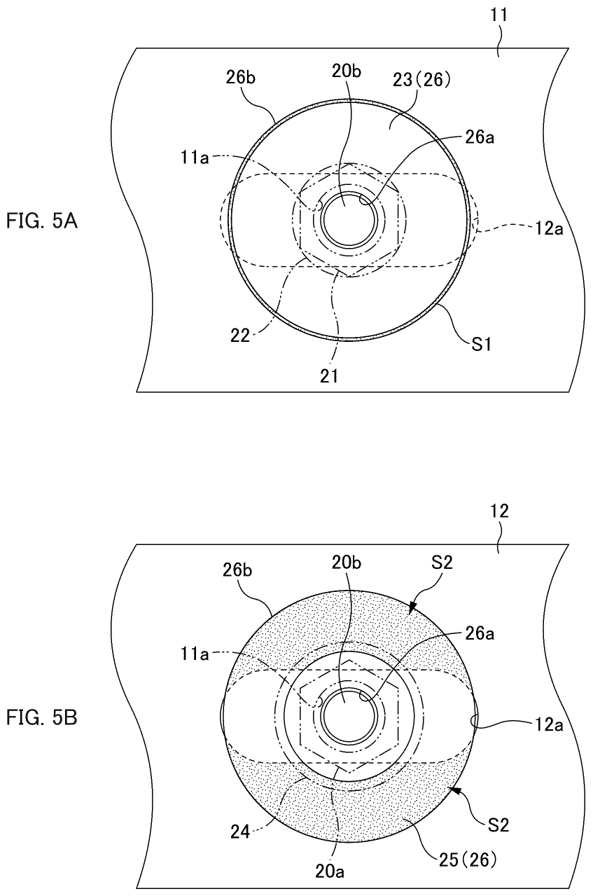

Thus, in a state where the nuts 21 are tightened to achieve a desired magnitude of the spring load-bearing force of the first disc spring sets 23, a contact area S1 of the first disc spring set 23 with the first pressure-contact plate 11 corresponds to the outer peripheral edge portion 26b of the disc spring 26, as illustrated in FIG. 5A. On the other hand, contact areas S2 of the second disc spring set 25 with the second pressure-contact plate 12 each have a larger width on the inner peripheral edge portion 26a side than on the outer peripheral edge portion 26b side, as illustrated in FIG. 5B. That is, the contact area S2 of the second disc spring set 25 with the second pressure-contact plate 12 becomes larger than the contact area S1 of the first disc spring set 23 with the first pressure-contact plate 11, and the disc spring 26 of the second disc spring set 25 is deformed to be flat, so that a portion facing the second pressure-contact plate 12 comes into full contact with the second pressure-contact plate 12.

When the disc springs 26 of the second disc spring sets 25 are deformed into a flat state and come into contact with the second pressure-contact plate 12, the disc springs 26 press the second pressure-contact plate 12 at regions where they are in contact with the second pressure-contact plate 12. That is, in each of the second disc spring sets 25, the second pressure-contact plate 12 is pressed at a contact region extending from the outer peripheral edge portion 26b of the disc spring 26 that is in contact with the second pressure-contact plate 12 to the inner peripheral edge portion 26a of the disc spring 26.

Thus, for example, unlike a case where only a flat washer is disposed between a second pressure-contact plate and a head portion, the outer peripheral edge portion of the flat washer does not warp in a direction away from the second pressure-contact plate, and the second pressure-contact plate is not pressed solely on the inner peripheral edge portion side of the flat washer that is in contact with the nut. Therefore, as a result of the second pressure-contact plate 12 being pressed by the second disc spring sets 25, the second pressure-contact plate 12 can be pressed at positions more away from the high-strength bolts 20 than in the case of using a flat washer.

In addition, the disc springs 26 of the second disc spring sets 25 deform into the flat state to increase the contact area S2 between the second disc spring sets 25 and the second pressure-contact plate 12, so that the spring load-bearing force can be distributed and applied over a wider region to press the second pressure-contact plate 12. Consequently, the pressing force is less likely to be concentrated at a narrow region, and thus, generation of frictional heat between the first pressure-contact plate 11 and the second pressure-contact plate 12 can be suppressed. This can prevent reduction in the frictional force due to generation of high frictional heat.

Note that, in the present embodiment, each of the first washers 22 is a flat washer, and each of the second washers 24 is a washer that has the small annular portion 24a and the large annular portion 24b. However, there is no limitation on the configuration of the washers. For example, each of the first washers 22 may be a washer having a small annular portion and a large annular portion, and each of the second washers 24 may be a flat washer. Alternatively, both the first washers 22 and the second washers 24 may be flat washers, or both the first washers 22 and the second washers 24 may be washers each having a small annular portion and a large annular portion.

### First Modification

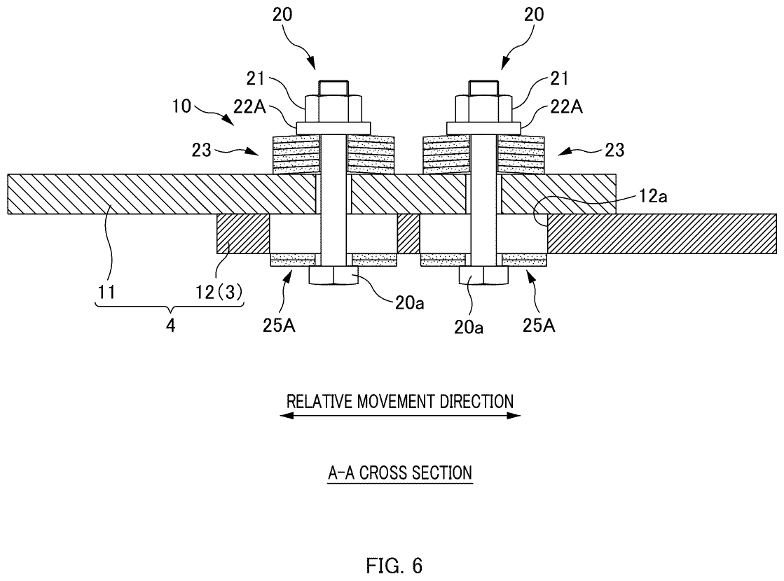

FIG. 6 is a diagram illustrating a friction damper according to a first modification. The friction damper illustrated in FIG. 6 includes first washers 22A and second disc spring sets 25A.

Note that the first washers 22 of the above-described embodiment each have a size (outer diameter) that is approximately equal to that of each of the nuts 21 (see FIG. 2 and FIG. 3). In this case, the height of each of the first disc spring sets 23 is measured at an end surface of the first disc spring set 23, the end surface being close to the nut 21. However, as illustrated in FIG. 3 and the like, such an end surface of each of the first disc spring sets 23 is oblique (inclined), and thus, it is difficult to accurately measure the height.

Then, in the first modification, the first washers 22A are arranged between the nuts 21 and the first disc spring sets 23. As illustrated in FIG. 6, each of the first washers 22A has a size (outer diameter) larger than that of the nut 21. This can measure the height of each of the first disc spring sets 23 at a part of each of the first washers 22A that projects outward from the nut 21. Therefore, the height of each of the first disc spring sets 23 can be determined by subtracting the thickness of the first washer 22A from a measured height. This facilitates accurate measurement of the height of each of the first disc spring sets 23.

In addition, in the first modification, only the second disc spring sets 25A are arranged close to the head portions 20a of the high-strength bolts 20 (arranged between the pressure-contact-plate stack 4 and the head portions 20a).

The inner diameter of each of the disc springs of the second disc spring sets 25A is slightly larger than the diameter of the shaft portion 20b of the high-strength bolt 20 and is smaller than the diameter of the head portion 20a of the high-strength bolt 20. As a result, the second disc spring sets 25A can be pressed by the head portions 20a of the high-strength bolts 20. Accordingly, the second washers 24, which are employed in the above-described embodiment, can be omitted. This can simplify the configuration of the friction damper. Note that, in FIG. 6, the dimensions of the disc springs of the second disc spring sets 25A and the disc springs of the first disc spring sets 23 are substantially equal to each other, but the dimensions thereof may differ from each other. In addition, the configuration on the head portions 20a side may be similar to that illustrated in FIG. 2 and FIG. 3, and the washers (here, the first washers 22A) arranged close to the nuts 21 may be omitted.

### Second Modification

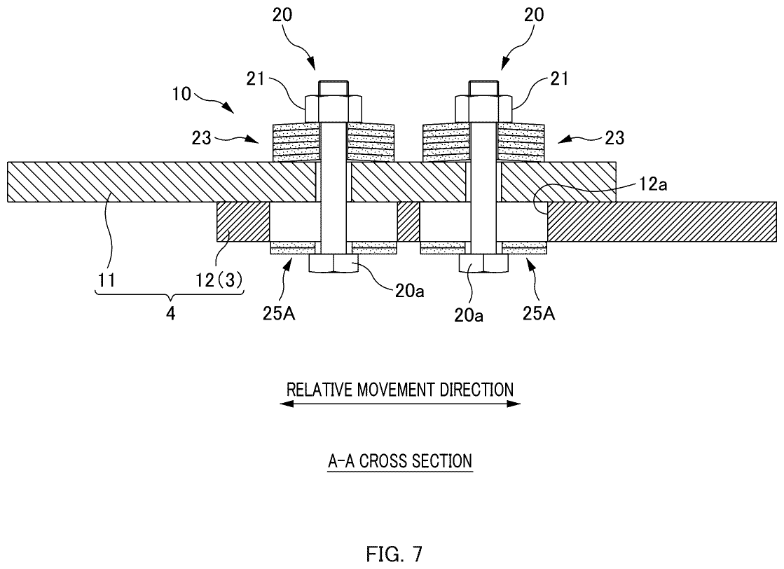

FIG. 7 is a diagram illustrating a second modification of the friction damper. In the second modification, as illustrated in FIG. 7, only the second disc spring sets 25A are arranged close to the head portions 20a of the high-strength bolts 20 (arranged between the pressure-contact-plate stack 4 and the head portions 20a), and only the first disc spring sets 23 are arranged close to the nuts 21 (arranged between the pressure-contact-plate stack 4 and the nuts 21). That is, in the second modification, washers are omitted on both the head portions 20a side of the high-strength bolts 20 and the nuts 21 side.

Also in such a case of the second modification, the disc spring sets are provided on both sides of the pressure-contact-plate stack 4 (the first disc spring sets 23 are provided on one side of the pressure-contact-plate stack 4, and the second disc spring sets 25A are provided on the other side of the pressure-contact-plate stack 4), which can press the pressure-contact-plate stack 4 at positions away from the axes (shaft portions 20b) of the high-strength bolts 20. In addition, in the second modification, the configuration of the friction damper can be further simplified.

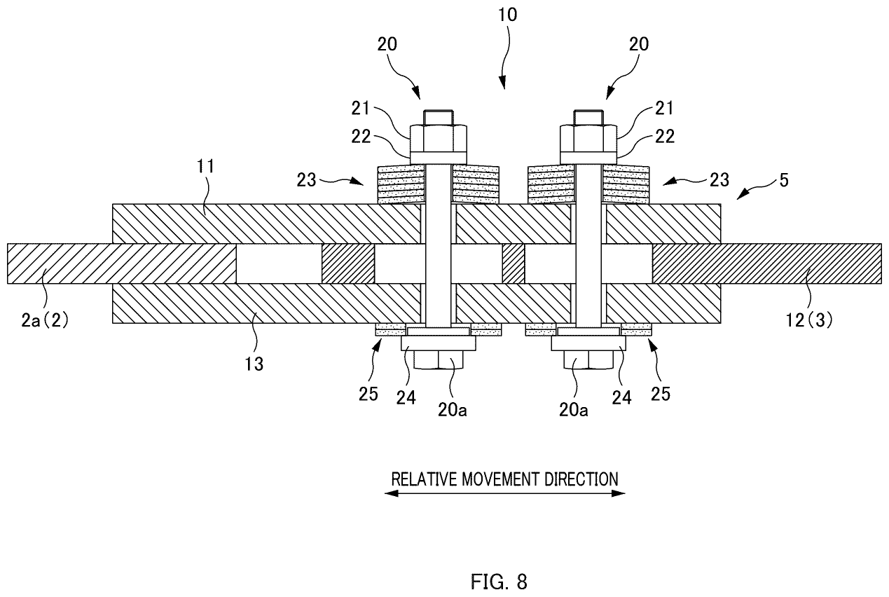

In the above-described embodiment, the case has been described in which the pressure-contact-plate stack 4 includes the first pressure-contact plate 11 and the second pressure-contact plate 12. However, the configuration of the pressure-contact-plate stack 4 is not limited thereto, and the pressure-contact-plate stack 4 may include three or more pressure-contact plates stacked on each other. For example, as illustrated in FIG. 8, the pressure-contact-plate stack may include three pressure-contact plates.

In this case, the friction damper 10 includes the first pressure-contact plate 11, the second pressure-contact plate 12, a third pressure-contact plate 13, the high-strength bolts 20, the nuts 21, the first washers 22, the first disc spring sets 23, the second washers 24, and the second disc spring sets 25. The first pressure-contact plate 11 and the third pressure-contact plate 13 are bolted to the web 2a of the brace-divided piece 2. The web 3a of the brace-divided piece 3 serves as the second pressure-contact plate 12 as it is. The high-strength bolts 20 pass through a pressure-contact-plate stack 5 that includes the first pressure-contact plate 11, the second pressure-contact plate 12, and the third pressure-contact plate 13 that are stacked on each other. The nuts 21 are screwed onto their respective high-strength bolts 20. The first washers 22 and the first disc spring sets 23 are arranged close to the nuts 21. The second washers 24 and the second disc spring sets 25 are arranged close to the head portions 20a. By tightening the nuts 21, the disc springs 26 of the second disc spring sets 25 are deformed to be flat, so that a portion facing the third pressure-contact plate 13 comes into full contact the third pressure-contact plate 13.

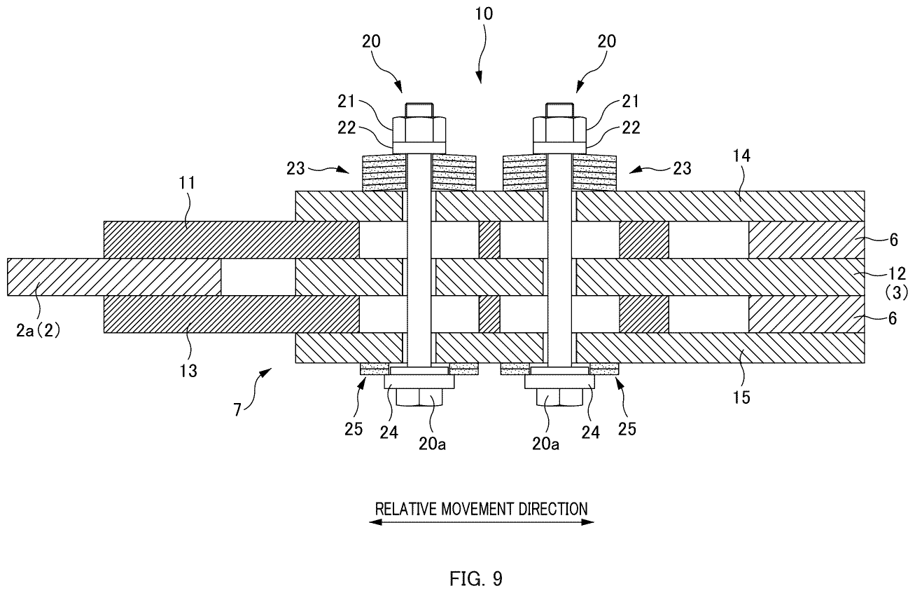

In addition, as illustrated in FIG. 9, the pressure-contact-plate stack may include five pressure-contact plates. In this case, the friction damper 10 includes the first pressure-contact plate 11, the second pressure-contact plate 12, the third pressure-contact plate 13, a fourth pressure-contact plate 14, a fifth pressure-contact plate 15, the high-strength bolts 20, the nuts 21, the first washers 22, the first disc spring sets 23, the second washers 24, and the second disc spring sets 25. The first pressure-contact plate 11 and the third pressure-contact plate 13 are bolted to the web 2a of the brace-divided piece 2. The web 3a of the brace-divided piece 3 serves as the second pressure-contact plate 12 as it is. The fourth pressure-contact plate 14 is bolted to one surface of the web 3a via a filler plate 6, and the fifth pressure-contact plate 15 is bolted to the other surface of the web 3a via another filler plate 6. The high-strength bolts 20 pass through a pressure-contact-plate stack 7 that includes the first to fifth pressure-contact plates 11, 12, 13, 14, and 15 that are stacked on each other. The nuts 21 are screwed onto their respective high-strength bolts 20. The first washers 22 and the first disc spring sets 23 are arranged close to the nuts 21. The second washers 24 and the second disc spring sets 25 are arranged close to the head portions 20a. By tightening the nuts 21, the disc springs 26 of the second disc spring sets 25 are deformed to be flat, so that a portion facing the fifth pressure-contact plate 15 comes into full contact the fifth pressure-contact plate 15. Note that the above-described first and second modifications can also be similarly applied to the configurations illustrated in FIG. 8 and FIG. 9.

In the above-described embodiment, the case has been described in which each of the first disc spring sets 23 is constituted by the six disc springs 26 and in which each of the second disc spring sets 25 is constituted by the two disc springs 26, which are the same as those included in the first disc spring sets 23. However, there is no limitation on the number of the disc springs 26. The number of the disc springs 26 included in each of the disc spring sets 23 and 25 may be any number as long as the number of the disc springs 26 included in each of the first disc spring sets 23 is greater than the number of the disc springs 26 included in each of the second disc spring set 25. Each of the second disc spring sets 25 may be constituted by one disc spring 26.

In addition, in the above-described embodiment, the case has been described in which the first disc spring sets 23 and the second disc spring sets 25 employ the same disc springs 26. However, the configuration is not limited thereto, and a configuration of each disc spring of the first disc spring sets 23 may be different from that of each disc spring of the second disc spring sets 25. In this case, the amount of bending-deformation of each of the second disc spring sets 25 against load is set to be larger than the amount of bending-deformation of each of the first disc spring sets 23 against load.

Furthermore, in the above-described embodiment, the case has been described in which the first disc spring sets 23 are arranged close to the nuts 21, and the second disc spring sets 25 are arranged close to the head portions 20a. However, the present disclosure is not limited to this, and the first disc spring sets 23 may be arranged close to the head portions 20a, and the second disc spring sets 25 may be arranged close to the nuts 21.

### Other Embodiments

Although the embodiments of the present disclosure have been described above, the above-described embodiments are provided to facilitate the understanding of the present disclosure and are not intended to limit the scope of the present disclosure. In addition, the present disclosure may be modified or improved without departing from the spirit thereof, and it goes without saying that the present disclosure includes equivalents thereof.

1. An aerodynamic bearing for the axial and radial mounting of a shaft extending along a rotation axis for a turbo compressor, the aerodynamic bearing comprising:
two annular axial bearing disks and a hollow cylindrical radial bearing bush,
wherein the two axial bearing disks and the radial bearing bush are arranged concentrically to the rotation axis,
wherein the two axial bearing disks are spaced apart in the axial direction and form a cavity between them in the axial direction for receiving a shaft sleeve connected to the shaft,
wherein the two axial bearing disks each have an axial bearing surface facing the cavity for forming a respective axial gas cushion in a respective axial bearing gap between the respective axial bearing surface and the shaft sleeve for the axial mounting of the shaft,
wherein the radial bearing bush has a radial bearing surface radially inward for forming a radial gas cushion in a radial bearing gap between the radial bearing surface and the shaft for the radial mounting of the shaft,
and wherein the radial bearing bush is formed integrally and/or materially with one of the axial bearing disks as a combination bearing bush.

2. The aerodynamic bearing according to claim 1,
wherein a spacer disk is arranged in the axial direction between the two axial bearing disks, which spacer disk is designed to hold the axial bearing disks at a predetermined axial distance from one another and/or to delimit the cavity in the radial direction, so that the shaft sleeve, when mounted as intended between the axial bearing disks by the axial gas cushions, is rotatable,
and wherein the spacer disk is formed integrally and/or materially with the combination bearing bush.

3. The aerodynamic bearing according to claim 1,
wherein the combination bearing bush has a hollow cylindrical shape, the length of which corresponds to a common axial length of the radial bearing bush and the axial bearing disk and the outer radius of which corresponds to an outer radius of the axial bearing disk.

4. The aerodynamic bearing according to claim 1,
wherein the axial bearing surface and the radial bearing surface on the combination bearing bush transition through a transition region which runs concentrically around the rotation axis and is concave and configured as an undercut.

5. The aerodynamic bearing according to claim 1,
further having at least one first venting channel leading to the axial bearing surface and to the radial bearing surface of the combination bearing bush for decoupling the axial gas cushion and the radial gas cushion.

6. The aerodynamic bearing according to claim 5,
wherein the at least one first venting channel leads to the transition region, via which the at least one first venting channel is fluidically connected to the axial bearing surface and the radial bearing surface.

7. The aerodynamic bearing according to claim 5,
wherein the at least one first venting channel leads from the radial bearing surface to a radially outer circumferential surface and/or an axial end face of the combination bearing bush and is configured to maintain an ambient pressure of the combination bearing bush.

8. The aerodynamic bearing according to claim 1,
wherein the radial bearing surface of the combination bearing bush is divided into at least two radial bearing surface portions spaced apart in the axial direction for forming a respective radial gas cushion between the respective radial bearing surface portion and the shaft for the radial mounting of the shaft.

9. The aerodynamic bearing according to claim 8,
further having at least one second venting channel arranged between two radial bearing surface portions and leading to the radial bearing surface portions for decoupling the adjacent radial gas cushions.

10. The aerodynamic bearing according to claim 2,
further having at least one third venting channel extending in the radial direction through the spacer disk to at least one of the axial bearing surfaces for decoupling at least one of the axial gas cushions.

11. The aerodynamic bearing according to claim 1,
wherein the combination bearing bush is solid
and/or wherein the combination bearing bush is designed to dissipate heat from the axial bearing surface and the radial bearing surface radially outward to conduct it to a cooling medium and/or a heat sink.

12. The aerodynamic bearing according to claim 1,
further comprising the shaft sleeve non-rotationally connected to the shaft in particular by a fastening element
or further comprising the shaft with the shaft sleeve integrally formed thereon and/or materially connected thereto.

13. A turbo compressor with an aerodynamic bearing according to claim 1,
having a receiving body which defines a cylindrical receiving space for receiving the combination bearing bush, further comprising retaining webs extending in the radial direction into the receiving space and which are designed to hold the combination bearing bush in the receiving space concentrically to the rotation axis.

14. The turbo compressor according to claim 13,
wherein in the circumferential direction between the retaining webs and delimited radially inward by the combination bearing bush at least one axial channel is provided for homogenizing an ambient pressure prevailing around the combination bearing bush,
and/or wherein at least one circumferential channel is provided, which intersects the retaining webs in the circumferential direction and which is delimited radially inward by the combination bearing bush, for homogenizing an ambient pressure prevailing around the combination bearing bush.
